(19) United States
(12) Patent Application Publication
(10) Pub. No.: US 2013/0141221 A1
(43) Pub. Date: Jun. 6, 2013

(54) Apparatus

(71) Applicants: Markku Anttoni Oksanen, Helsinki (FI); Martti Kalevi Voutilainen, Espoo (FI); Jari-Jukka Harald Kaaja, Jarvenpaa (FI)

(72) Inventors: Markku Anttoni Oksanen, Helsinki (FI); Martti Kalevi Voutilainen, Espoo (FI); Jari-Jukka Harald Kaaja, Jarvenpaa (FI)

(73) Assignee: NOKIA CORPORATION, Espoo (FI)

(21) Appl. No.: 13/519,549

(22) PCT Filed: Dec. 31, 2009
(86) PCT No.: PCT/EP2009/068062

§ 371 Date: Dec. 17, 2012

(51) Int. Cl. G06K 19/07

(52) U.S. Cl. CPC G06K 19/0728
USPC 340/10.5

(57) ABSTRACT

An apparatus comprising at least one processor and at least one memory including computer program code the at least one memory and the computer program code configured to, with the at least one processor, cause the apparatus at least to perform: receiving a radio frequency signal; determining dependent the radio frequency signal at least one characteristic of an apparatus; and displaying the characteristic of the apparatus by generating at least two audio signals, each audio signal comprising a modulated tone configured to produce an image dependent on the at least one characteristic.

The present invention relates to apparatus for augmenting perception using audio signals. The invention further relates to, but is not limited to, apparatus for augmenting perception using audio signals in audio playback devices.

Augmented reality, where the users own senses are ‘improved’ by the application of further sensor data, is a rapidly developing topic of research. For example the use of sensors to receive sound, video, and environmental data which may be processed and then output to a user to improve or focus a user's perception of the environment has become a hotly researched topic. One augmented reality application in common use is environmental noise cancellation where audio signals are captured using an array of microphones, the captured audio signals may then be inverted then output to the user to improve the user's experience. For example in noise cancelling headsets, playback speaker or ear worn speaker carrying devices (ESD) this inversion may be output to the user reducing the ambient noise and allowing the user to listen to other audio signals at a much lower sound level then would be otherwise possible.

However the use of headsets and specifically active noise cancelling headsets with portable music devices has itself become problematic as it is dangerous to use the devices in built up areas due to the isolation effect produced. Pedestrians using such headsets do not remove them prior to attempting to cross roads and are often surprised by fast moving cyclists or electric vehicles approaching outside their range of vision. Similarly bicyclists wearing such headphones become psychologically isolated to such an extent that they often do not notice traffic lights with red stop signals or pedestrian crossings and pass through these endangering both pedestrians crossing the road and also endangering their own lives by significantly increasing the possibility of a collision with vehicles approaching from the other direction. This problem has reached a point where some towns are planning to restrict the use of devices when crossing roads or while operating vehicles such as bicycles or cars to attempt to reduce accidents caused by such devices.

Environmental isolation may be found in other situations, for example in poor visibility conditions for example fog or mist in which pedestrians, and vehicle users such as bicyclists, motorists or car users may find it difficult to see other vehicles or objects of interest.

Furthermore environmental isolation may be caused by a disability such as blindness or partial sightedness. Although some aids are available they can lack the ability to provide an immersive experience. For example although the game of football has been adapted by the attachment of a bell or similar audio signal source to the ball, such approaches are limited in allowing the person to determine the difference between different players and who is on which team.

This invention proceeds from the consideration that an improved environmental awareness may be achieved by radio frequency identification being used to modify a simple audio tone which is directionally configured to improve the safety of the user.

Embodiments of the present invention aim to address the above problem.

There is provided according to a first aspect of the invention a method comprising: receiving a radio frequency signal; determining dependent the radio frequency signal at least one characteristic of an apparatus; and displaying the characteristic of the apparatus by generating at least two audio signals, each audio signal comprising a modulated tone configured to produce an image dependent on the at least one characteristic.

The at least one characteristic of the apparatus may comprise the direction of the apparatus relative to a receiving apparatus, and wherein the at least two audio signals are preferably amplitude and/or phase modulated tones configured to produce the effect of hearing a sound source with a direction of the apparatus relative to the receiving apparatus.

Determining the direction of the apparatus relative of the receiving apparatus may comprise at least one of: determining which antenna in an preconfigured array of antennas receives the radio frequency signal with the highest power and selecting the direction associated with the antenna; and beamforming the received radio-frequency signal to determine the direction from which the radio frequency is received with the highest power.

The characteristic of the apparatus may comprise the relative apparatus speed of the apparatus, and wherein the at least two audio signals are preferably frequency modulated tones to produce the effect of hearing a sound source with the relative apparatus speed.

Determining the relative apparatus speed of the apparatus may comprise: determining a frequency shift of the received radio frequency signal compared to a predetermined frequency; and estimating the relative apparatus speed of the apparatus dependent on the frequency shift.

The characteristic of the apparatus may comprise the distance of the apparatus relative to a receiving apparatus, and wherein the at least two audio signals are preferably modulated tones to produce the effect of hearing a sound source with the distance of the apparatus relative to a receiving apparatus.

Determining the distance of the apparatus relative to a receiving apparatus may comprise: determining a phase delay period of the received radio frequency signal; and estimating distance of the apparatus relative to a receiving apparatus dependent on the a phase delay period.

The at least two audio signals modulated to produce the effect of hearing a sound source with the distance of the apparatus relative to a receiving apparatus preferably comprises: modulating the amplitude of the at least two audio signals inversely proportional to the distance; repeating the tone with a delay period proportional to the distance.

The characteristic of the apparatus may comprise the type of the apparatus, and wherein the at least two audio signals are preferably frequency modulated tones.

Determining the type of the apparatus may comprise: determining the radio frequency signal carrier wave frequency; and selecting a type of apparatus dependent on the radio frequency signal carrier wave frequency.

Displaying the characteristic of the apparatus may further comprise at least one of: visually displaying the characteristic; haptically displaying the characteristic; and vibrationally displaying the characteristic.

The method may further comprise: generating an initialisation signal; and transmitting the initialisation signal to the apparatus prior to receiving the radio frequency signal from the apparatus.

According to a second aspect of the invention there is provided a method comprising: receiving a radio frequency signal; generating a response radio frequency signal, wherein the response radio frequency signal comprises a carrier wave identifying the type of the apparatus receiving the radio frequency signal.

According to a third aspect of the invention there is provided an apparatus comprising at least one processor and at least one memory including computer program code the at least one memory and the computer program code configured to, with the at least one processor, cause the apparatus at least to perform: receiving a radio frequency signal; determining dependent the radio frequency signal at least one characteristic of a further apparatus; and displaying the characteristic of the further apparatus by generating at least two audio signals, each audio signal comprising a modulated tone configured to produce an image dependent on the at least one characteristic.

The at least one characteristic of the further apparatus may comprise the direction of the further apparatus relative to the apparatus, and wherein the at least two audio signals are preferably amplitude and/or phase modulated tones configured to produce the effect of hearing a sound source with a direction of the further apparatus relative to the apparatus.

Determining the direction of the further apparatus relative of the apparatus may cause the apparatus at least to perform at least one of: determining which antenna in an preconfigured array of antennas receives the radio frequency signal with the highest power and selecting the direction associated with the antenna; and beamforming the received radio-frequency signal to determine the direction from which the radio frequency is received with the highest power.

The characteristic of the further apparatus may comprise the relative apparatus speed of the further apparatus, and wherein the at least two audio signals are preferably frequency modulated tones to produce the effect of hearing a sound source with the relative apparatus speed.

Determining the relative apparatus speed of the further apparatus may cause the apparatus at least to perform: determining a frequency shift of the received radio frequency signal compared to a predetermined frequency; and estimating the relative apparatus speed of the further apparatus dependent on the frequency shift.

The characteristic of the further apparatus may comprise the distance of the further apparatus relative to the apparatus, and wherein the at least two audio signals are preferably modulated tones to produce the effect of hearing a sound source with the distance of the further apparatus relative to the apparatus.

Determining the distance of the further apparatus relative to the apparatus preferably cause the apparatus at least to perform: determining a phase delay period of the received radio frequency signal; and estimating distance of the further apparatus relative to the apparatus dependent on the a phase delay period.

The at least two audio signals preferably modulated to produce the effect of hearing a sound source with the distance of the further apparatus relative to the apparatus cause the apparatus at least to preferably perform: modulating the amplitude of the at least two audio signals inversely proportional to the distance; and repeating the tone with a delay period proportional to the distance.

The characteristic of the further apparatus may comprise the type of the further apparatus, and wherein the at least two audio signals are preferably frequency modulated tones.

Determining the type of the further apparatus may cause the apparatus at least to perform: determining the radio frequency signal carrier wave frequency; and selecting a type of further apparatus dependent on the radio frequency signal carrier wave frequency.

Displaying the characteristic of the further apparatus may further cause the apparatus at least to perform at least one of: visually displaying the characteristic; haptically displaying the characteristic; and vibrationally displaying the characteristic.

The computer program code configured to, with the at least one processor, cause the apparatus at least to further preferably perform: generating an initialisation signal; and transmitting the initialisation signal to the further apparatus prior to receiving the radio frequency signal from the further apparatus.

According to a fourth aspect of the invention there is provided an apparatus comprising at least one processor and at least one memory including computer program code the at least one memory and the computer program code configured to, with the at least one processor, cause the apparatus at least to perform: receiving a radio frequency signal; and generating a response radio frequency signal, wherein the response radio frequency signal comprises a carrier wave identifying the type of the further apparatus receiving the radio frequency signal.

According to a fifth aspect of the invention there is provided an apparatus comprising: a receiver configured to receive a radio frequency signal; a signal processor configured to determine dependent the radio frequency signal at least one characteristic of a further apparatus; and display the characteristic of the further apparatus by generating at least two audio signals, each audio signal comprising a modulated tone configured to produce an image dependent on the at least one characteristic.

The at least one characteristic of the further apparatus may comprise the direction of the apparatus relative to the apparatus, and wherein the signal processor is configured to preferably amplitude and/or phase modulated tones of the at least two audio signals to produce the effect of hearing a sound source with a direction of the further apparatus relative to the apparatus.

The signal processor preferably comprises at least one of: a directional detector configured to determine which antenna in an preconfigured array of antennas receives the radio frequency signal with the highest power and selecting the direction associated with the antenna; and a beamformer configured to beamform the received radio-frequency signal to determine the direction from which the radio frequency is received with the highest power.

The characteristic of the further apparatus may comprises the relative apparatus speed of the further apparatus, and wherein the signal processor is configured to frequency modulate tones of at least two audio signals to produce the effect of hearing a sound source with the relative apparatus speed.

The signal processor preferably comprises a frequency shift determiner configured to determine a frequency shift of the received radio frequency signal compared to a predetermined frequency; and speed determiner configured to estimate the relative apparatus speed of the further apparatus dependent on the frequency shift.

The characteristic of the further apparatus may comprise the distance of the further apparatus relative to the apparatus, wherein the signal processor is configured to preferably modulate a tone of the at least two audio signals to produce the effect of hearing a sound source with the distance of the further apparatus relative to the apparatus.

The signal processor preferably comprises a phase delay estimator configured to determine a phase delay period of the received radio frequency signal; and distance estimator configured to estimate a distance of the further apparatus relative to the apparatus dependent on the phase delay period.

The signal processor may comprise an amplitude modulator configured to modulate the amplitude of the at least two audio signals inversely proportional to the distance; and to repeat the tone with a delay period proportional to the distance.

The characteristic of the further apparatus may comprise the type of the further apparatus, and wherein signal processor may comprise a frequency modulator configured to frequency modulate the at least two audio signals.

The signal processor may comprise: a frequency discriminator configured to determine the radio frequency signal carrier wave frequency; and an apparatus type selector configured to selecting a type of further apparatus dependent on the radio frequency signal carrier wave frequency.

The apparatus may further comprise a display configured to display the characteristic of the further apparatus further comprises at least one of: visually displaying the characteristic; haptically displaying the characteristic; and vibrationally displaying the characteristic.

The apparatus may further comprise a transmitter configured to generate an initialisation signal; and transmit the initialisation signal to the further apparatus prior to receiving the radio frequency signal from the further apparatus.

According to a sixth aspect of the invention there is provided an apparatus comprising: a receiver configured to receive a radio frequency signal; and transmitter configured to generate a response radio frequency signal, wherein the response radio frequency signal comprises a carrier wave identifying the type of the apparatus receiving the radio frequency signal.

According to a seventh aspect of the invention there is provided an apparatus comprising: receiving means configured to receive a radio frequency signal;

processing means configured to determine dependent the radio frequency signal at least one characteristic of an apparatus; and to display the characteristic of the apparatus by generating at least two audio signals, each audio signal comprising a modulated tone configured to produce an image dependent on the at least one characteristic.

According to an eighth aspect of the invention there is provided an apparatus comprising: receiver means configured to receive a radio frequency signal; and transmitter means configured to generate a response radio frequency signal, wherein the response radio frequency signal comprises a carrier wave identifying the type of the apparatus receiving the radio frequency signal.

According to a ninth aspect of the invention there is provided a computer-readable medium encoded with instructions that, when executed by a computer perform: receiving a radio frequency signal; determining dependent the radio frequency signal at least one characteristic of an apparatus; and displaying the characteristic of the apparatus by generating at least two audio signals, each audio signal comprising a modulated tone configured to produce an image dependent on the at least one characteristic.

According to a tenth aspect of the invention there is provided a computer-readable medium encoded with instructions that, when executed by a computer perform: receiving a radio frequency signal; and generating a response radio frequency signal, wherein the response radio frequency signal comprises a carrier wave identifying the type of the apparatus receiving the radio frequency signal.

An electronic device may comprise apparatus as described above.

A chipset may comprise apparatus as described above.

For better understanding of the present invention, reference will now be made by way of example to the accompanying drawings in which:

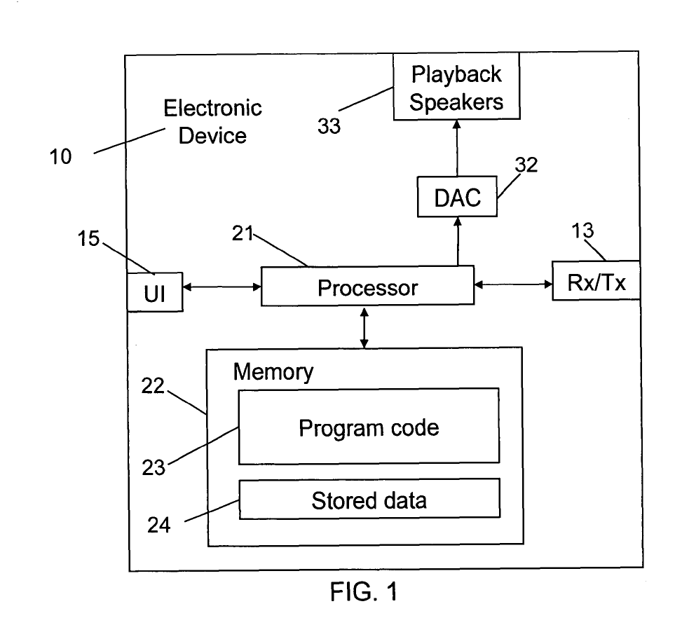

FIG. 1 shows schematically an electronic device employing embodiments of the application;

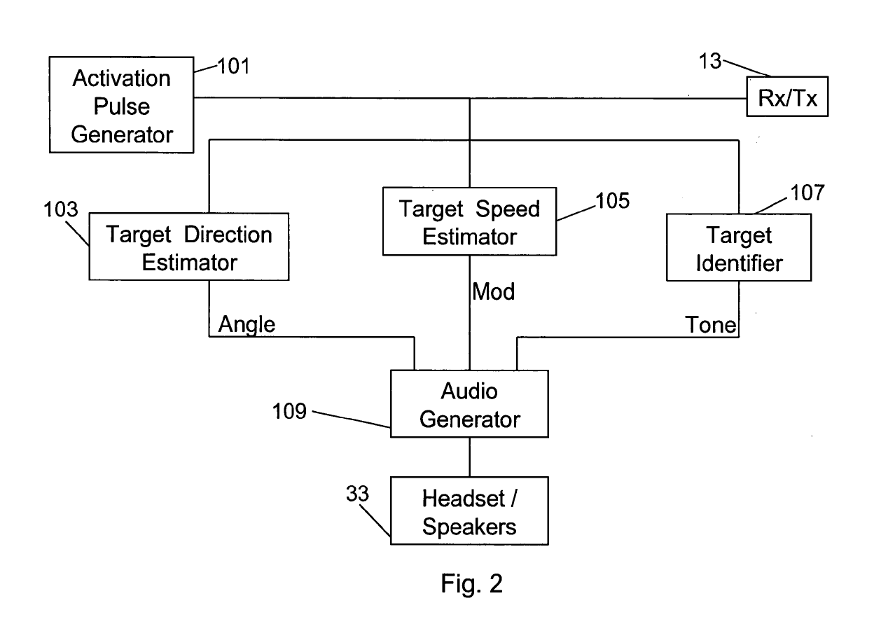

FIG. 2 shows schematically the electronic device shown in FIG. 1 in further detail with respect to environment target identification and estimation;

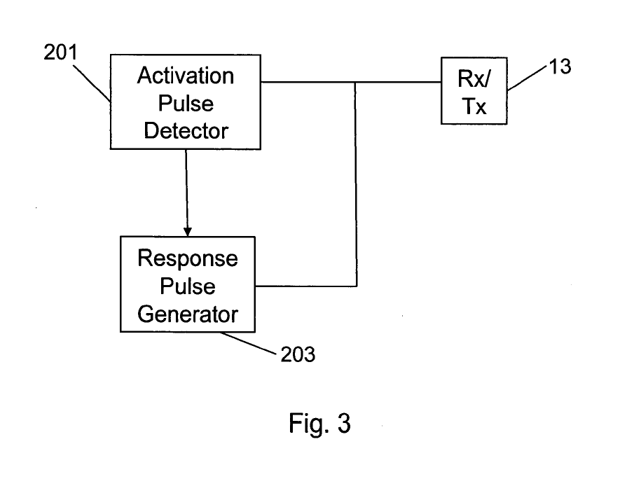

FIG. 3 shows schematically the electronic device shown in FIG. 1 in further detail with respect to providing information to be sensed; and

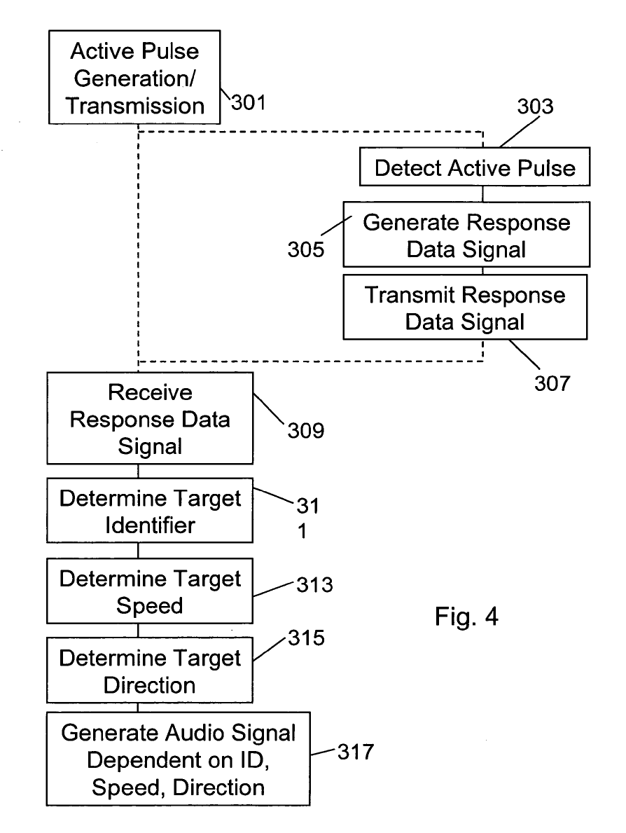

FIG. 4 shows schematically a flow chart illustrating the operation of some embodiments of the application.

The following describes apparatus and methods for the provision of enhancing augmented reality applications. In this regard reference is first made to FIG. 1, a schematic block diagram of an exemplary electronic device 10 or apparatus, which may incorporate an augmented reality capability.

The apparatus 10 may for example be a mobile terminal or user equipment for a wireless communication system. In other embodiments the electronic device may be any audio player (also known as mp3 players) or a media player (also known as mp4 players), or portable music player equipped with suitable sensors.

The electronic device 10 comprises a processor 21 which may be linked via a digital-to-analogue converter (DAC) 32 to playback speaker. The playback speaker in some embodiments may be connected to the apparatus via a headphone connector. The playback speaker may for example be a headphone or headset 33 or any suitable audio transducer equipment suitable to output acoustic waves to a user's ears from the electronic audio signal output from the DAC 32. In some embodiments the playback speakers 33 may themselves comprise the DAC 32. Furthermore in some embodiments the playback speakers 33 may connect to the electronic device 10 wirelessly via a transmitter or transceiver, for example by using a low power radio frequency connection such as Bluetooth A2DP profile.

The processor 21 is further linked to a transceiver (TX/RX) 13, to a user interface (UI) 15 and to a memory 22.

The processor 21 may be configured to execute various program codes. The implemented program codes may in some embodiments comprise an augmented reality channel extractor for generating augmented reality outputs to the playback speakers 33. The implemented program codes 23 may be stored for example in the memory 22 for retrieval by the processor 21 whenever needed. The memory 22 could further provide a section 24 for storing data, for example data that has been processed in accordance with the embodiments.

The augmented reality application code may in embodiments be implemented in hardware or firmware.

The user interface 15 enables a user to input commands to the electronic device 10, for example via a keypad and/or a touch interface. Furthermore the electronic device or apparatus 10 may comprise a display. The processor in some embodiments may generate image data to inform the user of the mode of operation and/or display a series of options from which the user may select using the user interface 15. For example the user may select an augmented reality mode of operation on the apparatus to activate the augmented reality operation or select the mode of transport the apparatus is using to render the apparatus discoverable to other apparatus, or select a specific ID value associated with the apparatus/use of the apparatus. In some embodiments the user interface 15 in the form of a touch interface may be implemented as part of the display in the form of a touch screen user interface.

The transceiver 13 in some embodiments enables communication with other electronic devices, for example via cellular or mobile phone gateway servers such as Node B or base transceiver stations (BTS) and a wireless communication network, or short range wireless communications to the microphone array or EWS where they are located remotely from the apparatus. In some embodiments the transceiver is operable to transmit and/or receive low power radio frequency signals such as Bluetooth, Zigbee, Wibree (BT LE), or other suitable modulation/protocols operating in the unlicensed 2.4 GHz band.

Furthermore the apparatus in some embodiments may comprise a sensor bank 16. The sensor bank 16 receives directly information about the environment within which the apparatus 10 is operating and passes this information to the processor 21. The sensor bank 16 may comprise at least one of the following set of sensors.

The sensor bank 16 may comprise a camera module. The camera module may in some embodiments comprise at least one camera having a lens for focusing an image on to a digital image capture means such as a charged coupled device (CCD). In other embodiments the digital image capture means may be any suitable image capturing device such as complementary metal oxide semiconductor (CMOS) image sensor. The camera module further comprises in some embodiments a flash lamp for illuminating an object before capturing an image of the object. The flash lamp is linked to a camera processor for controlling the operation of the flash lamp. The camera may be also linked to a camera processor for processing signals received from the camera. The camera processor may be linked to camera memory which may store program codes for the camera processor to execute when capturing an image. The implemented program codes (not shown) may in some embodiments be stored for example in the camera memory for retrieval by the camera processor whenever needed. In some embodiments the camera processor and the camera memory are implemented within the apparatus processor 21 and memory 22 respectively.

Furthermore in some embodiments the camera module may be physically implemented on the playback speaker apparatus 33 to provide images from the viewpoint of the user. For example in some embodiments the at least one camera may be positioned to capture images approximately in the eye-line of the user. In some other embodiments at least one camera may be implemented to capture images out of the eye-line of the user, such as to the rear of the user or to the sides of the user. In some embodiments the configuration of the cameras is such to capture images completely surrounding the user—in other words providing 360 degree coverage.

In some embodiments the sensor bank 16 comprises a position/orientation sensor. The orientation sensor in some embodiments may be implemented by a digital compass or solid state compass. In some embodiments the position/orientation sensor is implemented as part of a satellite position system such as a global positioning system (GPS) whereby a receiver is able to estimate the position of the user from receiving timing data from orbiting satellites. Furthermore in some embodiments the GPS information may be used to derive orientation and movement data by comparing the estimated position of the receiver at two time instances.

In some embodiments the sensor bank 16 further comprises a motion sensor in the form of a step counter. A step counter may in some embodiments detect the motion of the user as they rhythmically move up and down as they walk. The periodicity of the steps may themselves be used to produce an estimate of the speed of motion of the user in some embodiments. In some further embodiments of the application, the sensor bank 16 may comprise at least one accelerometer and/or gyroscope configured to determine and change in motion of the apparatus. The motion sensor may in some embodiments be used as a rough speed sensor configured to estimate the speed of the apparatus from a periodicity of the steps and an estimated stride length. In some further embodiments the step counter speed estimation may be disabled or ignored in some circumstances—such as motion in a vehicle such as a car or train where the step counter may be activated by the motion of the vehicle and therefore would produce inaccurate estimations of the speed of the user.

With respect to FIGS. 2 and 3, schematic views of the apparatus shown in FIG. 1 are shown in further detail. Specifically FIG. 2 shows a detail of the apparatus of FIG. 1 from the viewpoint of the apparatus detecting other apparatus and providing to the user of the apparatus an augmented reality in the form of generation of an audio signal to improve the user's experience of the apparatus. With respect to FIG. 3, the apparatus is shown in further detail from the viewpoint of the apparatus making itself detectable to other apparatus. It would be understood that a single apparatus may comprise components such as described hereafter that render the apparatus capable of being detectable or detecting only or capable of both being detectable by other apparatus and detecting other apparatus. FIG. 4 shows the operations to some embodiments of the sensing of both detecting and being detectable by other apparatus.

It would be appreciated that the schematic structures described in FIGS. 2 and 3 and the method steps in FIG. 4 represent only a part of the operation of an audio chain comprising some embodiments as exemplarily shown implemented in the apparatus shown in FIG. 1. In particular the following schematic structures do not describe in detail the operation of auralization and the perception of hearing in terms of the localized sounds from different sources. Furthermore the following description does not detail the generation of binaural signals for example using head related transfer functions (HRTF) or impulse response related functions (IRRF) to train the processor to generate audio signals calibrated to the user. However such operations are known by the person skilled in the art.

The embodiments of the application may be operated on the apparatus 10, for example a mobile device when operated in a special “alert” mode of operation. In such embodiments when the apparatus detects signals generated by other mobile devices or other “active” apparatus, such as audio players (MP3 players, etc.) with radio frequency transmitter capabilities such as Bluetooth devices, as the other apparatus approaches the detecting apparatus to provide the user of the detecting apparatus a warning signal. In such embodiments, detection is carried out by using the radio frequency signal (such as Bluetooth or other similar short range radio signalling). For simplicity, with respect to the following embodiments and examples the radio frequency signal is a Bluetooth protocol signal. However in other embodiments, other suitable radio frequency signals may be used. For example in some embodiments the transmitters and receivers may operate over the unlicensed 2.4 GHz frequency bands. In other embodiments the transmitters and receivers may operate over any suitable frequency bands using the Industrial, Scientific and Medical (ISM) bands such as the 60 GHz band which is suitable for producing short directional wireless connections.

Furthermore in some embodiments as described later, the apparatus can be configured to not only detect “target” devices but may also be used to distinguish between different types of identifiable targets. Thus in some embodiments the detectable apparatus may be configured to send information identifying its type to warn other detecting apparatus according to its type of apparatus. For example in some embodiments, a bicyclist who wants to ride quickly and also wishes to warn pedestrians would switch their apparatus to a function of a special detectable bicyclist alert mode in order that any detecting apparatus which are approached at speed can be warned.

In some embodiments, the detecting apparatus may select a warning audio based on an estimated direction of detection and the warning based on a stereographic audio image generated by the apparatus using the playback speaker to create a three dimensional image of the environment using detected surrounding apparatus.

In some embodiments the type identifier may identify types of vehicle, or types of player, for example which team they play for or which “position” they occupy. For example in football games members of the same team can have the same ID type and every member of the player team can in some embodiments receive three dimensional audio images for their team members, the other team or specific selected team members. Although the following examples are described with respect to a road or traffic accident avoidance system, it would be appreciated that similar embodiments may be employed to assist finding or tracking any suitable person or object of interest equipped with suitable RF beacon capacity. Thus the same principle as described hereafter may be extended to any other suitable tracking or targeting system including the indication or targeting of people, buildings, vehicles, animals and other objects of interest.

Thus in some embodiments the system may be used as a ‘wireless luminous tag’ enabling operators of apparatus in vehicles the ability to ‘detect’ potential hazards before seeing them.

Furthermore in some other embodiments the targeting and/or tracking of buildings may be used to assist navigation tasks as such building location detection information may used to assist in determining the estimated location apparatus for example in built up areas where satellite systems may not produce accurate results.

As described above with respect to FIG. 2, the apparatus from the viewpoint of the detecting apparatus is shown in further detail. The apparatus in some embodiments comprises an activation pulse generator 101. The activation pulse generator 101 generates a pulse control signal to the transmitter/receiver or transceiver 13. The pulse may contain information indicating that the current user of the apparatus wishes to be warned of or detect other apparatus. The activation pulse generator 101 passes the activation pulse to the transceiver 13 to be transmitted. The activation pulse generator 101 in some embodiments may be initialised on receiving an input from the user interface. For example the user interface may initialise the activation pulse generator 101 on receiving an input that the apparatus is in an “alert mode”. In some embodiments the activation pulse generator 101 may receive an indication on what the apparatus wants to detect. The user interface in some embodiments may configure the activation pulse generator 101 to output an activation signal requesting only specific other apparatus types to respond and be detectable. Thus the type wished to be detected may be bicycles or electric cars only (in other words vehicles which are quiet in operation only).

In some embodiments there is no activation pulse and no activation pulse generator 101.

In some embodiments the activation pulse generator 101 transmits information concerning a detectable base band bandwidth within which the apparatus may be configured to receive detectable apparatus based information from other apparatus. In some further embodiments the activation pulse generator 101 transmits with the activation pulse information a synchronisation time frame or base clock.

The operation of generating and transmitting the activation pulse is shown in FIG. 4 by step 301.

With respect to FIG. 3, the apparatus 10 is shown with respect of the viewpoint of the “detectable” apparatus or apparatus part.

The transceiver 13, which in some embodiments where the apparatus is both detectable and detecting, may be the same transceiver which both transmits and receives the detectable signals.

The transceiver passes the activation pulse information to the activation pulse detector 201.

The activation pulse detector 201 is configured in some embodiments to receive the signals from the transceiver 13 and determine whether or not there is any detecting apparatus within a detecting range which wishes to be informed of the detectable apparatus. In some embodiments this may involve determining the type of mode of the detectable apparatus and determines if this type of mode matches a requested type or mode information from the received activation pulse signal.

The activation pulse detector 201 when detecting the pulse and/or matching its conditions then activates the response pulse generator 203.

The detection of the active pulse operation is shown in FIG. 4 by step 303.

In some embodiments, where for example there is no activation pulse transmitted from apparatus to apparatus, the response pulse generator 203 may be activated manually by the operator of the detectable device or may be activated semi-automatically. For example in some embodiments comprising a motion detector, when the motion detector determines that the detectable apparatus is moving at a speed greater than a predefined value the response pulse generator may be triggered to make the apparatus detectable.

The response pulse generator 203 is configured in some embodiments to generate a response pulse or response data signal to be transmitted via the transceiver 13 to a detecting apparatus.

The response pulse generator 203 in some embodiments generates the response pulse dependent on the control signal from the activation pulse detector 201. For example in some embodiments the activation pulse detector may determine a base clock which may be used to synchronise both the detecting and the detectable apparatus in order to allow the detecting apparatus to more accurately determine distance and velocity.

Furthermore in some embodiments the response pulse generator 203 may generate a response pulse or data signal with the amplitude, phase or frequency indicated from the detectable or detecting apparatus. Thus in some embodiments the response pulse generator 203 may generate a response pulse amplitude, phase of frequency depending on the type or mode of detectable apparatus. For example the response pulse generator 203 may indicate a different narrowband carrier wave may be used dependent on whether or not the apparatus is travelling on a person, on a bicycle, or in a car or other vehicle. In other embodiments the response pulse generator 203 may generate a response signal which is dependent on the detected speed of the detectable device. Thus for example in some embodiments detectable apparatus may generate a carrier wave pulse with a frequency when the apparatus is moving at a speed lower than a certain threshold value and a different carrier wave frequency when the apparatus is operating above the predetermined threshold value in order that the detecting apparatus may determine how fast the device is moving.

In some embodiments the response pulse generator 203 is configured to control the generation of a carrier wave and its amplitude, frequency or phase modulation which is dependent on an identification value of the detectable apparatus. Thus a first carrier wave pulse may be generated for a team or a selection of players from a first team and a second carrier wave pulse generated for a second team (or a different selection of players from the first team).

In some embodiments the response pulse generator 203 is configured to control the generation of the carrier wave and a modulation in order to convey information about any further detectable apparatus which has been recently detected by the detectable apparatus and pass this information on. In these embodiments the effect of the network of detectable apparatus being able to pass this information on would be to extend the coverage range of the detecting apparatus.

Furthermore the detecting apparatus may in some embodiments where it detects at least one apparatus directly—in other words by receiving a response pulse from the detectable apparatus, and indirectly—in other words receiving a response pulse containing information on the location of the detectable apparatus from a further detectable apparatus then the detecting apparatus may use this information to further refine the estimate of speed, direction or distance between the apparatus.

The generation of response data signals is shown in FIG. 4 by step 305.

The response pulse generator passes the information to the transceiver 13 which then is transmitted via the low power radio frequency link such as the Bluetooth link to the detecting apparatus. In some embodiments the Bluetooth link may be a fixed time or synchronised Bluetooth link which requires the transceiver of the sensing device to be synchronised with the transceiver of the transmitting device. In these embodiments the synchronisation may be carried out based on the original activation signal.

The transmission of the response data signal is shown in FIG. 4 by step 307.

The detecting apparatus in some embodiments further comprises a target identifier 107. The target identifier 107 in some embodiments is configured to receive at least part of the received response pulse from at least one detectable apparatus and determine the type of apparatus based on the received part. The target identifier 107 for example may determine a “type” of detectable apparatus from the frequency of the pulse. Thus in a first embodiment the received signals may be filtered either at the RF band or base band to detect the type of detectable apparatus. The target identifier 107 may then output a tone control signal to the audio generator 109 indicating which tone to be displayed or output on detection of the detectable apparatus. Thus in some embodiments dependent on the carrier wave or modulation received different tones control signals may be generated dependent on the identification value.

Furthermore the sensing apparatus may further comprise a target speed estimator 105. The target speed estimator may on receiving the narrowband carrier wave signal via the radio frequency transceiver 13 may estimate a Doppler frequency shift from the response pulse and thus determine whether the detectable apparatus or target is approaching or receding from the detecting device and furthermore in some embodiments estimate the speed at which the object is approaching or receding.

In some embodiments a distance to or speed of the detectable apparatus may be estimated by determining the timing of flight on a Bluetooth burst-to-burst basis where the change in time of flight (in other words whether the pulse train is compressed later compared to earlier) is used to determine whether or not the target is approaching or receding from the detecting apparatus and at what speed the target is moving relative to the detecting apparatus. In some further embodiments the distance to the detectable apparatus may be estimated by determining the power of the received signal compared to the known transmitted power and an estimated attenuation or power loss per distance parameter.

The determination of the target speed is shown in FIG. 4 by step 313. The target speed estimator 105 may further output a modulation control signal to the audio generator 109, which may be used to modulate the tone generated by the audio generator.

The detecting apparatus 10 may further comprise a target direction estimator 103. The target direction estimator 103 may also receive the received response pulse or signals from the transceiver 13 and based on the received signals from the transceiver 13 estimate a direction of reception angle.

Any suitable direction estimation procedure may be used. For example in some embodiments where there are multiple radio frequency antennas, the antenna that receives the radio frequency pulse with the strongest signal indicates a general angle of direction from the device that sent the response pulse. In further embodiments the array of radio frequency antennas may be tuned using beamforming, to produce a narrow beam receiver which may be swept in order to detect the direction of the target relative to the detecting apparatus.

The output of the target direction estimator 103 is in some embodiments an angle of orientation control signal which may be passed to the audio generator 109.

The operation of determining the target direction is shown in FIG. 4 by step 315.

The audio generator 109 may receive input in some embodiments from the target direction estimator in terms of an angle input, the target speed estimator 105 in terms of a modulation input and from the target identifier 107 in terms of a tone indicator. The audio generator may then generate a tone which is modulated dependent on the target speed and/or distance and then projected in the direction according to the angle indicator.

Any suitable imaging technique may be used to mix the audio signal, for example using a head related transfer function (HRTF) algorithm to generate left and right channel signals suitable for projecting a two dimensional audio image dependent on the object position, type, speed. In some embodiments multiple targets may be identified and multiple target tones generated and mixed together to produce a single audio signal. In some embodiments the audio generator 109 outputs each tone as a “passing train” type tone so that the tone or mono-frequency sound starts high when an object is approaching, goes low frequency when the object is receding. In some other embodiments, the audio generator 109 may generate a “sonar” user interface experience where a sent first pulse is followed by a returning received pulse which indicates the distance and relative speed of the object. Thus when the object is getting closer or going quicker, the time between the sent pulse and received pulse comes progressively shorter. In some embodiments the audio generator 109 may be further mixed with real audio sounds captured from the surroundings or may for example be output to a headset or speaker 33 which has a leaky audio configuration, i.e. the real audio sounds are not processed but merely pass from the outside to the headset cavity.

The audio generator 107 thus generates audio signals dependent on the target identification value, speed and direction. The generation of the audio signals is shown in FIG. 4 by step 317. The audio signal is then output by the headset or speaker to the user. In some embodiments the audio generator 109 outputs tones dependent only on the angle of detection. In other embodiments the audio generator 109 outputs tones dependent on the angle of direction and type—thus different types of detectable apparatus have a different tone projected at the angle associated with the angle of detection.

Thus in these embodiments it is possible that the user of the detecting apparatus is warned of neighbouring detectable apparatus.

Although the above embodiments describe the generation of tones in a simulated 2 dimensional or 3 dimensional region in order to warn the operator of the detecting apparatus it would be appreciated that the detecting apparatus may use the information to produce further warnings to be experienced by the user.

Thus in some embodiments a haptic response to the information may be used as a substitute or reinforce the experience as the apparatus vibrates dependent on the type of detectable apparatus, the direction of the detectable apparatus.

Furthermore in some embodiments the user interface in the form of the display may also be used to warn the user. Thus the apparatus may on determining at least one detectable apparatus display on the display information on the detectable apparatus. For example in some embodiments a ‘radar’ type display may be used to show a ‘blip’ on the screen or display which shows the estimated angle of the detectable apparatus, the approaching speed or distance of the detectable apparatus and the type of the detectable apparatus. In other embodiments the display may interrupt the operation of the detecting apparatus with a warning.

In some embodiments the information may be ‘displayed’ using any combination of audio, haptic and visual feedback.

In some embodiments the Bluetooth received signal may further contain a positional estimate generated from the device based on a GPS signal which may then be compared against a positional information from the sensing device to produce a GPS based positional difference which itself may be used in the audio generator to, for example, indicate the distance between the devices. In such devices, for example the sonar based user interface may be organised such that the returning pulse timing is relative to the GPS difference but the tone of the returning tone is modulated dependent on the speed of the device so that the faster the sensed device is moving towards the sensing device, then the higher the tone. Furthermore by using existing radio interfaces such as Bluetooth, ZigBee, Wibree (BTLE) or other known radio operating in the unlicensed watts 2.4 GHz band then such devices may be manufactured without significant additional cost to that already provided in many audio players today.

In some embodiments the audio generator 109 further resolves a front-back confusion. A front-back confusion is a well known phenomena of spatial hearing whereby the listener incorrectly localises a source to its mirror image position across the frontal plane. In other words in such an example, the user may mistakenly believe that the sensed device is approaching from the rear rather than the front or vice versa. In such embodiments the audio generator may overcome this by introducing a small amount of “head rotation” to the generated audio signal. It is known that the localisation error can be mitigated in real life by the user rotating their head. This may similarly be synthesized within the audio generator by applying a slight angle adjustment or differing to the audio signal generated which would be detected by the user and be able to be used by the user to determine the sound source position.

In other embodiments it would be understood that as the operator of the detecting apparatus detects a detectable apparatus they would turn to the direction indicated as a matter of instinct and thus would then determine if the detectable apparatus was approaching from the front or the rear.

Furthermore it would be understood that although the issue of detecting in the vertical plane is not explicitly mentioned the above comments as to front-back may be applied to determining on a vertical plane as the operator of the detecting apparatus would turn to the direction indicated on the horizontal plane and would then typically see or have prior warning of the detectable apparatus.

In the above examples we have described the use of embodiments of the application for a football game, however it would be appreciated that similar embodiments may be applied to any team sport where identification of team members or a ball or game object is required or useful.

Similarly other examples involve marine vehicle avoidance where the motorboats may be equipped with noise cancelling headsets which may using some embodiments as described above detect other boats or ships which may not be easily seen such as kayaks or other low profile boats.

Although the above examples describe embodiments of the invention operating within an electronic device 10 or apparatus, it would be appreciated that the invention as described below may be implemented as part of any audio processor. Thus, for example, embodiments of the invention may be implemented in an audio processor which may implement audio processing over fixed or wired communication paths, or wireless communication paths where the response time is short.

Thus user equipment may comprise an audio processor such as those described in embodiments of the invention above.

It shall be appreciated that the term electronic device and user equipment is intended to cover any suitable type of wireless user equipment, such as mobile telephones, portable data processing devices or portable web browsers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Thus in at least one embodiments there is an apparatus comprising at least one processor and at least one memory including computer program code the at least one memory and the computer program code configured to, with the at least one processor, cause the apparatus at least to perform: receiving a radio frequency signal; determining dependent the radio frequency signal at least one characteristic of an further apparatus; and displaying the characteristic of the further apparatus by generating at least two audio signals, each audio signal comprising a modulated tone configured to produce an image dependent on the at least one characteristic.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

Thus in summary in some embodiments there may be a computer-readable medium encoded with instructions that, when executed by a computer perform: receiving a radio frequency signal; determining dependent the radio frequency signal at least one characteristic of an further apparatus; and displaying the characteristic of the further apparatus by generating at least two audio signals, each audio signal comprising a modulated tone configured to produce an image dependent on the at least one characteristic.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-26. (canceled)

27. A method comprising:
receiving a radio frequency signal;
determining dependent the radio frequency signal at least one characteristic of an apparatus; and
displaying the characteristic of the apparatus by generating at least two audio signals, each audio signal comprising a modulated tone configured to produce an image dependent on the at least one characteristic.

28. The method as claimed in claim 27, wherein the at least one characteristic of the apparatus comprises the direction of the apparatus relative to a receiving apparatus, and wherein the at least two audio signals are amplitude and/or phase modulated tones configured to produce the effect of hearing a sound source with a direction of the apparatus relative to the receiving apparatus.

29. The method as claimed in claim 28, wherein determining the direction of the apparatus relative of the receiving apparatus comprises at least one of:
determining which antenna in an preconfigured array of antennas receives the radio frequency signal with the highest power and selecting the direction associated with the antenna; and
beamforming the received radio-frequency signal to determine the direction from which the radio frequency is received with the highest power.

30. The method as claimed in claim 27, wherein the characteristic of the apparatus comprises the relative apparatus speed of the apparatus, and wherein determining the relative apparatus speed of the apparatus comprises: determining a frequency shift of the received radio frequency signal compared to a predetermined frequency; and estimating the relative apparatus speed of the apparatus dependent on the frequency shift.

31. The method as claimed in claim 27, wherein the characteristic of the apparatus comprises the distance of the apparatus relative to a receiving apparatus, and wherein determining the distance of the apparatus relative to a the receiving apparatus comprises: determining a phase delay period of the received radio frequency signal; and estimating distance of the apparatus relative to a receiving apparatus dependent on the a phase delay period.

32. The method as claimed in claim 31, wherein the at least two audio signals are modulated to produce the effect of hearing a sound source with the distance of the apparatus relative to a receiving apparatus comprises:
modulating the amplitude of the at least two audio signals inversely proportional to the distance;
repeating the tone with a delay period proportional to the distance.

33. The method as claimed in claim 27, wherein the characteristic of the apparatus comprises the type of the apparatus, and wherein determining the type of the apparatus comprises: determining the radio frequency signal carrier wave frequency; and selecting a type of apparatus dependent on the radio frequency signal carrier wave frequency.

34. The method as claimed in claim 27, wherein displaying the characteristic of the apparatus further comprises at least one of:
visually displaying the characteristic;
haptically displaying the characteristic; and
vibrationally displaying the characteristic.

35. The method as claimed in claim 27, further comprising:
generating an initialisation signal; and
transmitting the initialisation signal to the apparatus prior to receiving the radio frequency signal from the apparatus.

36. A method comprising:
receiving a radio frequency signal;
generating a response radio frequency signal, wherein the response radio frequency signal comprises a carrier wave identifying the type of the apparatus receiving the radio frequency signal.

37. An apparatus comprising at least one processor and at least one memory including computer program code the at least one memory and the computer program code configured to, with the at least one processor, cause the apparatus at least to:
receive a radio frequency signal;
determine dependent the radio frequency signal at least one characteristic of an further apparatus; and
display the characteristic of the further apparatus by generating at least two audio signals, each audio signal comprising a modulated tone configured to produce an image dependent on the at least one characteristic.

38. The apparatus as claimed in claim 37, wherein the at least one characteristic of the further apparatus comprises the direction of the further apparatus relative to the apparatus, and wherein the at least two audio signals are amplitude and/or phase modulated tones configured to produce the effect of hearing a sound source with a direction of the further apparatus relative to the apparatus.

39. The apparatus as claimed in claim 38, wherein causing the apparatus to determine the direction of the further apparatus relative of the apparatus causes the apparatus at least one of:
determine which antenna in an preconfigured array of antennas receives the radio frequency signal with the highest power and select the direction associated with the antenna;
beamform the received radio-frequency signal to determine the direction from which the radio frequency is received with the highest power.

40. The apparatus as claimed in claim 37, wherein the characteristic of the further apparatus comprises the relative apparatus speed of the further apparatus, and wherein causing the apparatus to determine the relative apparatus speed of the further apparatus causes the apparatus at least to: determine a frequency shift of the received radio frequency signal compared to a predetermined frequency; and estimate the relative apparatus speed of the further apparatus dependent on the frequency shift.

41. The apparatus as claimed in claim 37, wherein the characteristic of the further apparatus comprises the distance of the further apparatus relative to the apparatus, and wherein causing the apparatus to determine the distance of the further apparatus relative to the apparatus causes the apparatus at least to: determine a phase delay period of the received radio frequency signal; and estimate distance of the further apparatus relative to the apparatus dependent on the a phase delay period.

42. The apparatus as claimed in claim 41, wherein the at least two audio signals are modulated to produce the effect of hearing a sound source with the distance of the further apparatus relative to the apparatus causes the apparatus at least to:
modulate the amplitude of the at least two audio signals inversely proportional to the distance; and
repeat the tone with a delay period proportional to the distance.

43. The apparatus as claimed in claim 37, wherein the characteristic of the further apparatus comprises the type of the further apparatus, and wherein causing the apparatus to determine the type of the further apparatus causes the apparatus at least to: determine the radio frequency signal carrier wave frequency; and selecting a type of further apparatus dependent on the radio frequency signal carrier wave frequency.

44. The apparatus as claimed in claim 37, wherein causing the apparatus to display the characteristic of the further apparatus further causes the apparatus at least to at least one of:
visually display the characteristic;
haptically display the characteristic; and
vibrationally display the characteristic.

45. The apparatus as claimed in claim 37, the computer program code configured to, with the at least one processor, causes the apparatus at least to further:
generate an initialisation signal; and
transmit the initialisation signal to the further apparatus prior to receive the radio frequency signal from the further apparatus.

46. An apparatus comprising at least one processor and at least one memory including computer program code the at least one memory and the computer program code configured to, with the at least one processor, cause the apparatus at least to:
receive a radio frequency signal; and
generate a response radio frequency signal, wherein the response radio frequency signal comprises a carrier wave identifying the type of the further apparatus receiving the radio frequency signal.
